(19) United States
(12) Patent Application Publication
(10) Pub. No.: US 2021/0400155 A1
(43) Pub. Date: Dec. 23, 2021

(54) IMAGE READING APPARATUS AND IMAGE FORMING APPARATUS INCLUDING IMAGE READING APPARATUS

(71) Applicant: CANON KABUSHIKI KAISHA, Tokyo (JP)

(72) Inventors: Takayuki Fukushima, Ibaraki (JP); Yuichi Yamamoto, Ibaraki (JP)

(21) Appl. No.: 17/339,268

(22) Filed: Jun. 4, 2021

(30) Foreign Application Priority Data
Jun. 19, 2020 (JP) 2020-106244

(51) Int. Cl. H04N 1/00; B65H 1/04; B65H 31/02; B65H 1/08

(52) U.S. Cl. CPC H04N 1/00631; B65H 1/04; H04N 1/00559; B65H 1/08; H04N 1/00557; B65H 31/02

(57) ABSTRACT

An image reading apparatus includes a first stacking unit, a feeding unit, a reading unit, a second stacking unit onto which a document whose image is read by the reading unit is discharged, a rotating shaft, and protrusions. The first stacking unit includes a sheet stacking surface on which the document is stacked and includes an abutment portion on which one end portion of the document abuts. The feeding unit feeds the document stacked on the first stacking unit in a feed direction. The reading unit reads an image of the document conveyed by the feeding unit. The rotating shaft extends in the feed direction and supports the first stacking unit so as to be rotationally movable. The protrusions extends in a direction at a predetermined angle with respect to the feed direction, is arranged on the sheet stacking surface, and protrudes from the sheet stacking surface.

### BACKGROUND

### Field

The present disclosure relates to an image reading apparatus that reads an image of a document and an image forming apparatus that includes the image reading apparatus.

### Description of the Related Art

An image reading apparatus, such as a scanner, and an image reading apparatus mounted on, for example, a copying machine, have been provided with an auto document feeder (hereinafter referred to as an ADF) that continuously feeds sheets of a document stacked on a document tray, conveys the document to an image reading position, reads an image of the document, and thereafter discharges the document onto a discharge tray. Examples of the ADF include an ADF that aligns a width direction of a document by a user placing the document on the document tray and operating a side regulating plate arranged on the document tray.

Meanwhile, a known technology regarding the document tray to be used for the ADF is to incline the document tray toward a front side when the user sets a document to align the document using its own weight. With a configuration discussed in Japanese Patent Application Laid-Open No. H07-072685, a document tray is supported to be rotationally movable about a rotating shaft, and can be inclined toward the front side when the user sets a document on the document tray. With this configuration, the document set by the user moves under its own weight, and the document is aligned along a document abutment portion on the front side of the document tray.

In a case where the document tray is largely inclined toward the front side, a large space is required in an upper portion or a lower portion of the document tray, thereby upsizing an apparatus. Hence, the document tray has preferably a small inclination angle when the user sets the document on the document tray.

According to the configuration discussed in Japanese Patent Application Laid-Open No. H07-072685, however, since a sheet stacking surface of the document tray is a flat surface, a contact area between the document and the sheet stacking surface is equal in size to the document, and large frictional force that prevents the document from moving under its own weight occurs. There is therefore an issue that the configuration causes a large inclination angle necessary for moving the document set on the document tray under its own weight and aligning the document.

### SUMMARY

The present disclosure is directed to providing an image reading apparatus capable of decreasing an inclination angle of a document tray necessary for moving a document set on a document tray under its own weight and aligning the document, and an image forming apparatus that includes the image reading apparatus.

According to an aspect of the present disclosure, an image reading apparatus includes a first stacking unit including a sheet stacking surface on which a document is to be stacked, and an abutment portion on which one end portion of the document stacked on the sheet stacking surface in a width direction of the document abuts, a feeding unit configured to feed the document stacked on the first stacking unit in a feed direction orthogonal to the width direction, a reading unit configured to read an image of the document conveyed by the feeding unit, a second stacking unit onto which the document whose image is read by the reading unit is to be discharged, a rotating shaft that extends in the feed direction and configured to support the first stacking unit so as to be rotationally movable, and a plurality of protrusions that extends in a direction at a predetermined angle with respect to the feed direction, is arranged on the sheet stacking surface, and protrudes from the sheet stacking surface.

Further features of the present disclosure will become apparent from the following description of exemplary embodiments with reference to the attached drawings.

### BRIEF DESCRIPTION OF THE DRAWINGS

FIG. 1 is a schematic sectional view of an image forming apparatus.

FIG. 2 is a schematic sectional view of an image reading apparatus.

FIG. 3 is a right side view illustrating a state of the image reading apparatus at the time of setting a document.

FIG. 4 is a right side view illustrating a state of the image reading apparatus at the time of feeding the document.

FIG. 5 is a top view of the image reading apparatus.

FIG. 6 is an enlarged sectional view of a sheet stacking surface of a document tray.

FIG. 7 is a top view of the image reading apparatus.

FIG. 8 is a top view of the image reading apparatus.

FIG. 9 is an enlarged sectional view of the sheet stacking surface of the document tray.

### DESCRIPTION OF THE EMBODIMENTS

An exemplary embodiments of the present disclosure will now be described with reference to the accompanying drawings.

### Configuration of Image Forming Apparatus

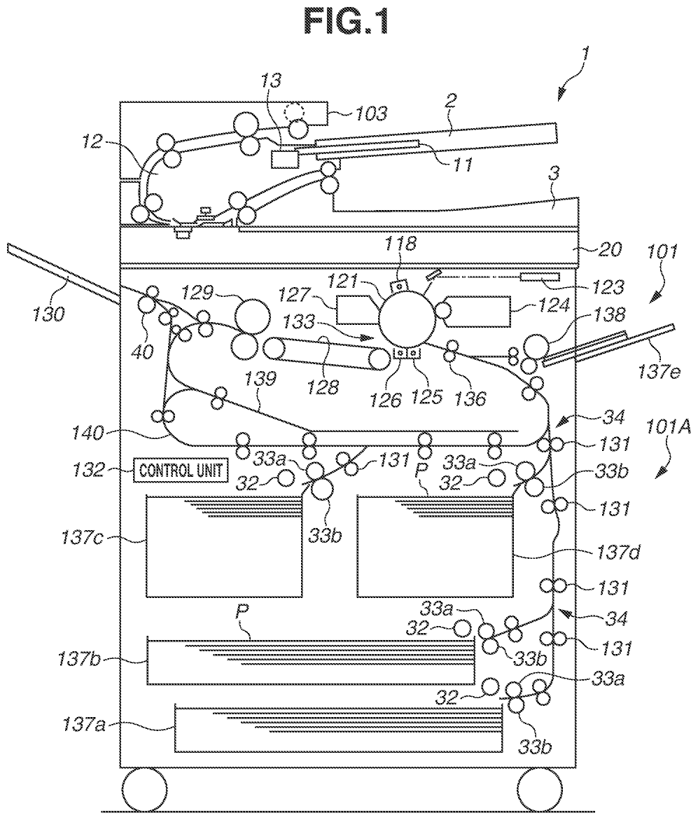

A schematic configuration of an image forming apparatus 101 according to an exemplary embodiment will be described with reference to FIG. 1. FIG. 1 is a schematic sectional view of the image forming apparatus 101 according to the present exemplary embodiment. A position at which a user operates an operation unit (not illustrated), to perform various kinds of input or settings with respect to the image forming apparatus 101 is hereinafter referred to as a “front side” of the image forming apparatus 101. A rear surface side with respect to the image forming apparatus 101 is hereinafter referred to as a “back side” of the image forming apparatus 101. That is, FIG. 1 illustrates an internal configuration of the image forming apparatus 101 when viewed from the front side.

The image forming apparatus 101 includes an apparatus body 101A and an image reading apparatus 103, as illustrated in FIG. 1. As described in detail later, the image reading apparatus 103 arranged above the apparatus body 101A includes a reader 20 and an auto document feeder (hereinafter referred to as an ADF) 1, and optically scans a document D to read image information. The document D mentioned herein is a sheet of, for example, paper including a document form and an envelope, a plastic film including an overhead projector sheet, and a cloth. The image information converted to electric signals by the image reading apparatus 103 is transferred to a controller 132 arranged in the apparatus body 101A. The apparatus body 101A forms an image on a sheet P, which is a recording material, based on an image read by the image reading apparatus 103.

The apparatus body 101A includes an image forming unit 133 for forming an image on the sheet P, which is the recording material, and a sheet feeding unit 34 that feeds the sheet P to the image forming unit 133. The sheet feeding unit 34 includes sheet storage units 137a, 137b, 137c, and 137d, which are capable of storing sheets in mutually different sizes. Sheets stored in each sheet storage unit are sent out by a pickup roller 32, separated sheet by sheet by a feed roller 33a and a retard roller 33b, and handed over to a corresponding pair of conveying rollers 131. The sheet P is sequentially handed over to a plurality of pairs of conveying rollers 131 arranged along a sheet conveying path, and then conveyed to a pair of registration rollers 136.

The sheet P loaded on a manual feed tray 137e by a user is fed to the inside of the apparatus body 101A by a feed roller 138 and conveyed to the pair of registration rollers 136. The pair of registration rollers 136 stops a leading end of the sheet P to correct skew feed, and also resumes conveyance of the sheet P in accordance with progress of an image formation operation, which is a process of forming a toner image performed by the image forming unit 133.

The image forming unit 133 that forms an image on the sheet P is an electrophotography image forming unit that includes a photosensitive drum 121, which is a photosensitive body. The photosensitive drum 121 is rotatable along a conveying direction of the sheet P. A charger 118, an exposure device 123, a developing device 124, a transfer charger 125, a separating charger 126, and a cleaner 127 are arranged around the photosensitive drum 121. The charger 118 uniformly charges the surface of the photosensitive drum 121. The exposure device 123 exposes the photosensitive drum 121 with light based on image information input from, for example, the image reading apparatus 103, and forms an electrostatic latent image on the photosensitive drum 121.

The developing device 124 contains developer including toner, and supplies charged toner to the photosensitive drum 121 to develop the electrostatic latent image to a toner image. The toner image carried by the photosensitive drum 121 is transferred to the sheet P, which is conveyed from the pair of registration rollers 136, by a bias electric field formed by the transfer charger 125. The sheet P to which the toner image is transferred is separated from the photosensitive drum 121 by the bias electric field formed by the separating charger 126, and is conveyed to a fixing unit 129 by a pre-fixing conveying unit 128. Attached materials, such as transfer residual toner that has not being transferred to the sheet P and left on the photosensitive drum 121, is removed by the cleaner 127, and the photosensitive drum 121 prepares itself for the next image formation operation.

The sheet P conveyed to the fixing unit 129 undergoes fixing processing including pressing and heating of the toner image while being nipped and conveyed by a pair of rollers. Toner is melted by this processing and thereafter fixated, whereby an image is fixed on the sheet P. In a case where image-output has been completed, the sheet P provided with the fixed image is discharged onto a discharge tray 130 protruding outward from the apparatus body 101A, via a pair of discharge rollers 40. In a case where an image is formed on the back surface of the sheet P in double-sided printing, the sheet P that has passed through the fixing unit 129 is flipped over by a reverse unit 139 such that the front surface and the back surface are replaced with each other, and then conveyed to the pair of registration rollers 136 by a double-sided conveying unit 140. The sheet P on which the image is formed again by the image forming unit 133 is discharged onto the discharge tray 130.

The image forming unit 133 described above is one example of an image forming unit, and an image forming unit of an inkjet method or a print mechanism of an offset print method may be used as the image forming unit.

### Configuration of Image Reading Apparatus

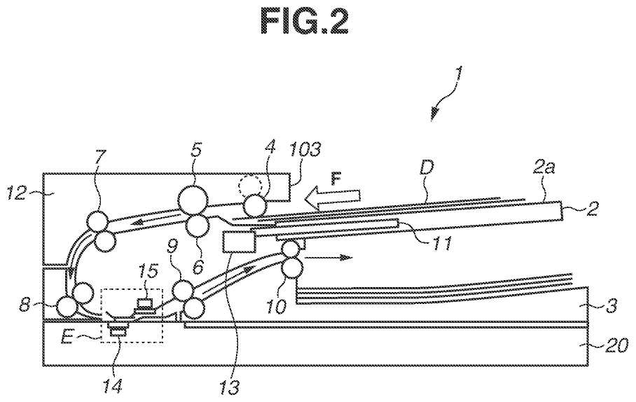

A schematic configuration of the image reading apparatus 103 will now be described with reference to FIG. 2. FIG. 2 is a schematic sectional view of the image reading apparatus 103. Sizes, materials, shapes, and relative arrangements of components, and the like described in the following exemplary embodiment are not intended to limit the scope of the present disclosure unless specifically described.

As illustrated in FIG. 2, the ADF 1 is composed of a document tray 2 serving as a first stacking unit, a conveying unit 12, and a discharge tray 3 serving as a second stacking unit. The discharge tray 3 is arranged below the document tray 2. The ADF 1 is attached to the top surface of the reader 20 to be openable and closable with a hinge portion (not illustrated), which is arranged on the back side of the apparatus. The ADF 1 conveys the document D to a reading position on a flow reading glass plate arranged on the top surface of the reader 20. The document D whose image is to be read is set on the document tray 2 mounted in the ADF 1. The document tray 2 is supported by a rotating shaft 11 that extends along a feed direction F so as to be rotationally movable with respect to the conveying unit 12. The feed direction F mentioned herein according to the present exemplary embodiment is a direction in which the document D is fed by a pickup roller 4 described below, and a direction along a sheet stacking surface 2a at the time of feeding paper. The feed direction F is orthogonal to a width direction of the document tray 2 at the time of feeding paper. The width direction mentioned herein is a main scanning direction when the image reading apparatus 103 reads an image on the document D.

Rotating the rotating shaft 11 also enables the document tray 2 to rotationally move about the rotating shaft 11 as a rotation center in an integral manner A motor 13 serving as a drive unit is arranged inside the conveying unit 12, and the document tray 2 is rotationally moved by rotational drive force of the motor 13. While the motor 13 is arranged inside the conveying unit 12 in the present exemplary embodiment, the arrangement of the motor 13 is not limited thereto. For example, the motor 13 may be arranged inside the document tray 2, or may be arranged close to the drive unit for providing rotational drive force to each conveying roller described below. The document tray 2 is configured such that the whole of the document tray 2 rotationally moves in the present exemplary embodiment, but may be configured such that only part of the document tray 2 (e.g., the sheet stacking surface 2a) rotationally moves.

The ADF 1 is provided with the pickup roller 4, a feed roller 5, a separating roller 6, a conveying roller 7, a conveying roller 8, a conveying roller 9, and a discharge roller 10. Further, an image reading section E is arranged on a downstream side in a conveying direction of the conveying roller 8. The image reading section E includes a front surface reading unit 14 mounted in the reader 20 and a back surface reading unit 15 mounted in the ADF 1.

The document D on the document tray 2 is sent out by the pickup roller 4 serving as a feeding unit, to the feed roller 5. The document is separated sheet by sheet by frictional force occurring between the feed roller 5 and the separating roller 6 urged by a spring from below the separating roller 6. The separated document D is sent to the image reading section E by the conveying rollers 7 and 8. Images on both sides of the document D sent to the image reading section E are read by the front surface reading unit 14 and the back surface reading unit 15, which constitute the reading unit. The document D is then conveyed to the discharge roller 10 by the conveying roller 9, and discharged onto the discharge tray 3 by the discharge roller 10.

### Configuration of Document Tray

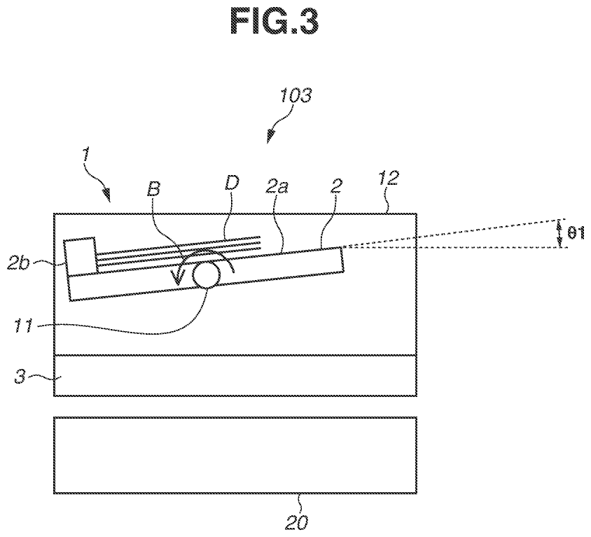

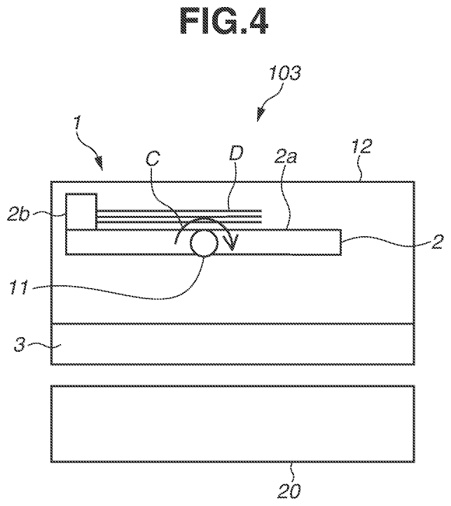

A description will now be given of a configuration of the document tray 2 with reference to FIGS. 3 and 4. FIG. 3 is a right side view of the image reading apparatus 103 illustrating a state of the document tray 2 at the time of setting the document D. FIG. 4 is a right side view of the image reading apparatus 103 illustrating a state of the document tray 2 at the time of feeding the set document D.

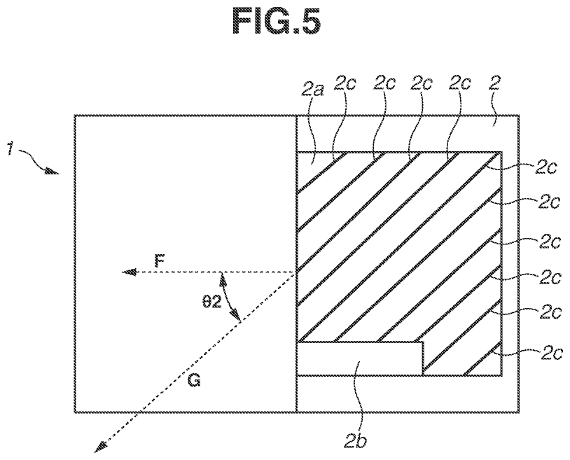

As illustrated in FIG. 3, the document tray 2 includes the sheet stacking surface 2a on which the document is stacked, and a document abutment portion 2b serving as an abutment portion. The document abutment portion 2b is fixed on the front side of the document tray 2. A plurality of ribs 2c described below is arranged on the sheet stacking surface 2a of the document tray 2 (refer to FIG. 5). When the user sets the document D, the document tray 2 rotationally moves about the rotating shaft 11, and the document tray 2 is inclined such that the document abutment portion 2b is lowered. That is, the document tray 2 rotationally moves in an arrow direction B illustrated in FIG. 3. The user then sets the document D in a first state in which the document tray 2 is inclined toward the front side (a state illustrated in FIG. 3). At this time, the sheet stacking surface 2a is inclined toward the front side by an angle θ1 with respect to the horizontal direction when the document tray 2 is viewed from a direction along the feed direction, and thereby the document D set by the user moves toward the document abutment portion 2b under its own weight. Thus, one end in the width direction of the document D that has moved under its own weight abuts the document abutment portion 2b, and the document D is aligned. This configuration can omit an operation of aligning the document D intentionally performed by the user, and thus can simplify setting of the document D. In the first state in which the sheet stacking surface 2a is inclined by the angle θ1 with respect to the horizontal direction, an end portion of the sheet stacking surface 2a on a downstream side in the feed direction F and an end portion of a guide, which constitutes a conveying path of the conveying unit 12, on an upstream side in the feed direction F are displaced. Hence, the ADF 1 is unable to perform a feed operation in the first state in which the document tray 2 is inclined toward the front side.

The angle θ1 is assumed to be 15° in the present exemplary embodiment, but is not limited to this value. The angle θ1 is preferably in a range of 0°<θ1<40°. This is because, in a case where the sheet stacking surface 2a is inclined by 40° or larger, there is a possibility that the set document D buckles under its own weight at the time of abutting the document abutment portion 2b. Further, a length in the feed direction F of the document abutment portion 2b is assumed to be 150 mm in the present exemplary embodiment in consideration of visibility at the time of setting the document D, but is not limited to this value.

As described above, the user sets the document D in the first state in which the document tray 2 is inclined toward the front side. In the state in which the document tray 2 is inclined toward to the front side, however, the ADF 1 is unable to perform the feed operation. Thus, after the document D is set, the document tray 2, with the document D remaining to be set, rotationally moves such that the position of the document abutment portion 2b is higher than the position in the first state illustrated in FIG. 3. That is, the document tray 2 rotationally moves in an arrow direction C illustrated in FIG. 4. The document tray 2 transitions to a second state (a state illustrated in FIG. 4) in which a position on the front side and a position on the back side are substantially equal to each other, accordingly. Thereafter, the ADF 1 starts the feed operation of the document D. At this time, the document tray 2 rotationally moves in response to the user's instruction for starting a reading operation of the not-illustrated operation unit.

When the document tray 2 is viewed from the direction along the feed direction F, the angle θ1 of the sheet stacking surface 2a with respect to the horizontal direction at the time of the start of the feed operation is assumed to be 0° in the present exemplary embodiment. However, the arrangement is only required to smoothly connect the sheet stacking surface 2a and the conveying path of the conveying unit 12 with each other at the time of the start of the feed operation. Hence, at the time of the start of the feed operation, the sheet stacking surface 2a may be somewhat inclined with respect to horizontal direction in a range in which the feed operation can be performed.

### Configuration of Sheet Stacking Surface

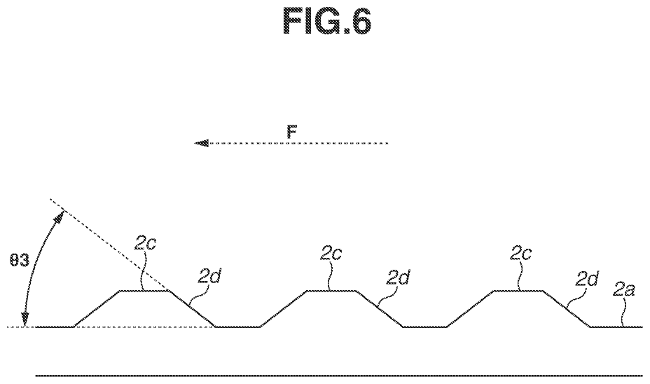

A detailed configuration of the sheet stacking surface 2a of the document tray 2 will now be described with reference to FIGS. 5 and 6. FIG. 5 is a top view of the image reading apparatus 103. FIG. 6 is an enlarged sectional view of the sheet stacking surface 2a for illustrating a sectional shape of the ribs 2c. The ribs according to the present exemplary embodiment are protrusions extending in one direction along a plane and protruding uniformly from the plane.

As illustrated in FIG. 5, the plurality of ribs 2c extending in an arrow direction G inclined by a predetermined angle θ2, which is 45° in the present exemplary embodiment, with respect to the feed direction F is arranged at intervals on the sheet stacking surface 2a. The ribs 2c are arranged at regular intervals in a direction orthogonal to the arrow direction G. The plurality of ribs 2c protrudes in a direction orthogonal to the sheet stacking surface 2a as illustrated in FIG. 6. Furthermore, an inclined portion 2d that is inclined by an angle θ3 with respect to the sheet stacking surface 2a is arranged in the rib 2c on the upstream side in the feed direction F. The inclined portion 2d arranged in the rib 2c is inclined in a direction of increasing heights from the upstream to the downstream in the feed direction F.

As described above, the document tray 2 is in the first state of being inclined toward the front side when the user sets the document D on the document tray 2. The document D set by the user moves on the inclined sheet stacking surface 2a under its own weight, and one end in the width direction of the document D abuts the document abutment portion 2b. The document D is thereby aligned. In the present exemplary embodiment, the document D is in contact only with the ribs 2c arranged on the sheet stacking surface 2a when moving on the sheet stacking surface 2a, and thereby frictional force that prevents the movement of the document D is small. For this reason, the present embodiment makes the set document D to easily move under its own weight, and decreases an inclination angle of the document tray 2 necessary for moving the set document D under its own weight and aligning the document D, in comparison with a case where no rib 2c is arranged on the sheet stacking surface 2a. Furthermore, decreasing the inclination angle of the document tray 2 for aligning the document D under its own weight can decrease a space for the document tray 2 to rotationally move, and downsize the apparatus.

If there is no rib 2c, the inclination angle θ1 of the sheet stacking surface 2a for aligning the document D under its own weight is approximately 30°. According to the present exemplary embodiment in which the ribs 2c are arranged on the sheet stacking surface 2a, in contrast, the inclination angle θ1 of the sheet stacking surface 2a for aligning the document D under its own weight is about 15°.

According to the present exemplary embodiment, the inclined portion 2d is arranged in the rib 2c on the upstream side in the feed direction F. Hence, the leading end of the document D moves along the inclined portion 2d when the user sets the document D on the document tray 2 from a right side surface of the ADF 1 along the feed direction F. This configuration can prevent the document D from getting stuck with the ribs 2c and being damaged.

### Modification Example of Ribs

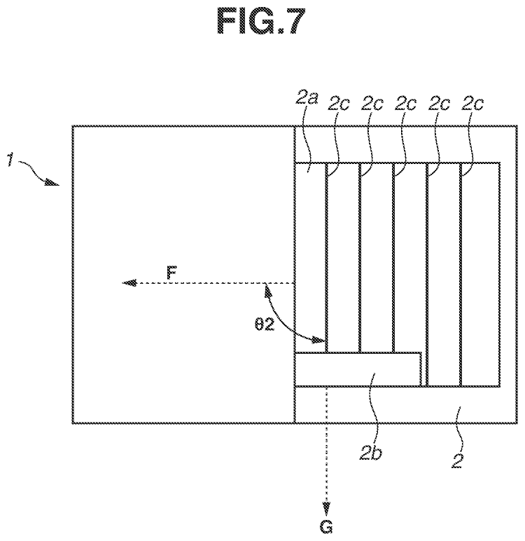

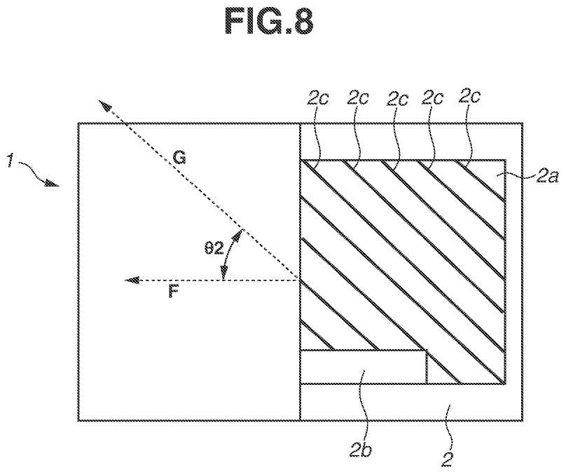

A modification example of the ribs 2c arranged on the sheet stacking surface 2a will now be described with reference to FIGS. 7 to 9. FIGS. 7 and 8 are top views of the image reading apparatus 103 for each illustrating another example of the angle θ2 of the ribs 2c with respect to the feed direction F. The ribs 2c are inclined by 45° toward the front side of the apparatus from the upstream to the downstream in the feed direction F in the above-mentioned exemplary embodiment as illustrated in FIG. 5. However, the predetermined angle θ2 is not limited to this value. For example, the predetermined angle θ2 may be 90° as illustrated in FIG. 7, and is preferably 40° or more and 90° or less (40°<θ2<90°) to infallibly align the document D under its own weight. The ribs 2c may also be inclined at the predetermined angle θ2 in a direction toward the back side of the apparatus from the upstream to the downstream in the feed direction F, as illustrated in FIG. 8.

The ribs 2c exemplified in the exemplary embodiment described above have a shape linearly extending in a direction having the predetermined angle θ2 with respect to the feed direction F. However, the shape of the ribs 2c is not limited thereto, and part of the ribs 2c may be inclined in another direction. Furthermore, the ribs 2c may extend in a curved line. In this case, an angle of a straight line connecting both end portions of each rib 2c in the curved line with respect to the feed direction F is assumed to be the predetermined angle θ2.

Alternatively, the ribs 2c may have such a shape as that a plurality of protrusions is linearly arranged on the sheet stacking surface 2a.

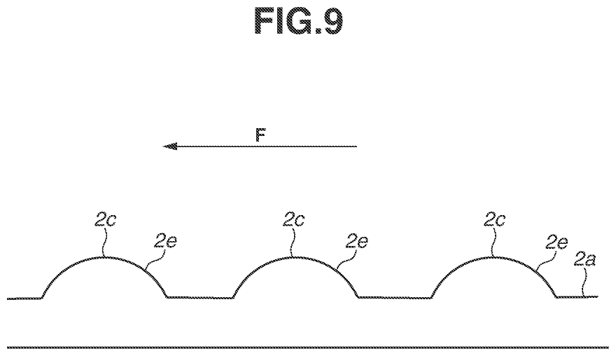

FIG. 9 is an enlarged sectional view of the sheet stacking surface 2a for illustrating another example of the sectional shape of the ribs 2c. The sectional shape of the rib 2c illustrated in FIG. 9 has a circular arc shape protruding in a vertical upper direction from the sheet stacking surface 2a. That is, the rib 2c has a curved surface portion 2e on the upstream side in the feed direction F. In this manner, even the ribs 2c each having the curved surface portion 2e on the upstream side in the feed direction F can prevent damage on the document D, because the leading end of the document D set by the user moves along the shape of the ribs 2c.

According to the present exemplary embodiment, it is possible to provide the image reading apparatus capable of decreasing the inclination angle of the document tray for moving the document set on the document tray under its own weight and aligning the document, and the image forming apparatus that includes the image reading apparatus.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2020-106244, filed Jun. 19, 2020, which is hereby incorporated by reference herein in its entirety.

What is claimed is:

1. An image reading apparatus comprising:
a first stacking unit including a sheet stacking surface on which a document is to be stacked, and an abutment portion on which one end portion of the document stacked on the sheet stacking surface in a width direction of the document abuts;
a feeding unit configured to feed the document stacked on the first stacking unit in a feed direction orthogonal to the width direction;
a reading unit configured to read an image of the document conveyed by the feeding unit;
a second stacking unit onto which the document whose image is read by the reading unit is to be discharged;
a rotating shaft that extends in the feed direction and configured to support the first stacking unit so as to be rotationally movable; and
a plurality of protrusions that extends in a direction at a predetermined angle with respect to the feed direction, is arranged on the sheet stacking surface, and protrudes from the sheet stacking surface.

2. The image reading apparatus according to claim 1, wherein the predetermined angle is 40° or more and 90° or less.

3. The image reading apparatus according to claim 1, wherein the plurality of protrusions each include an inclined portion on an upstream side in the feed direction.

4. The image reading apparatus according to claim 1, wherein the plurality of protrusions each include a curved surface portion on an upstream side in the feed direction.

5. The image reading apparatus according to claim 1, wherein the first stacking unit is configured to rotationally move about the rotating shaft in such a direction as to lower the abutment portion.

6. The image reading apparatus according to claim 1, further comprising a drive unit configured to rotationally move the first stacking unit about the rotating shaft.

7. An image forming apparatus comprising:
a first stacking unit including a sheet stacking surface on which a document is to be stacked, and an abutment portion on which one end portion of the document stacked on the sheet stacking surface in a width direction of the document abuts;
a feeding unit configured to feed the document stacked on the first stacking unit in a feed direction orthogonal to the width direction;
a reading unit configured to read an image of the document conveyed by the feeding unit;
a second stacking unit onto which the document whose image is read by the reading unit is to be discharged;
a rotating shaft that extends in the feed direction and configured to support the first stacking unit so as to be rotationally movable;
a plurality of protrusions that extends in a direction at a predetermined angle with respect to the feed direction, is arranged on the sheet stacking surface, and protrudes from the sheet stacking surface; and
an image formation unit configured to form an image on a recording material based on image information read by the reading unit.

8. The image forming apparatus according to claim 7, wherein the predetermined angle is 40° or more and 90° or less.

9. The image forming apparatus according to claim 7, wherein the plurality of protrusions each include an inclined portion on an upstream side in the feed direction.

10. The image forming apparatus according to claim 7, wherein the plurality of protrusions each include a curved surface portion on an upstream side in the feed direction.

11. The image forming apparatus according to claim 7, wherein the first stacking unit is configured to rotationally move about the rotating shaft in such a direction as to lower the abutment portion.

12. The image forming apparatus according to claim 7, further comprising a drive unit configured to rotationally move the first stacking unit about the rotating shaft.
